(19) United States
(12) Patent Application Publication
(10) Pub. No.: US 2024/0384144 A1
(43) Pub. Date: Nov. 21, 2024

(54) ADHESIVE KIT, ADHESION METHOD, AND ADHERED STRUCTURE

(71) Applicant: NITTO DENKO CORPORATION, Ibaraki-shi, Osaka (JP)

(72) Inventors: Yuto SUZUKI, Ibaraki-shi, Osaka (JP); Akiko TANAKA, Ibaraki-shi, Osaka (JP)

(21) Appl. No.: 18/696,565

(22) PCT Filed: Sep. 22, 2022
(86) PCT No.: PCT/JP2022/035545

§ 371 Date: Mar. 28, 2024

(30) Foreign Application Priority Data
Sep. 29, 2021 (JP) 2021-159642

(51) Int. Cl. C09J 163/00; C09J 5/04

(52) U.S. Cl. CPC C09J 163/00; C09J 5/04; C09J 2301/408; C09J 2301/50

(57) ABSTRACT

An adhesive kit includes: an adhesive layer containing an epoxy resin and an elastomer; and a curing agent liquid composition capable of curing the adhesive layer by contact and a reaction with the adhesive layer, in which the adhesive layer contains 1 mass % to 30 mass % of the elastomer.

### TECHNICAL FIELD

The present invention relates to an adhesive kit, an adhesion method, and an adhered structure.

### BACKGROUND ART

In the related art, as an adhesion method, there is known a method of using a two-component adhesive agent in which two liquids consisting of a main agent (liquid A) and a curing agent (liquid B) are mixed and used (for example, see Patent Literature 1 below).

In the adhesion method described in Patent Literature 1, the main agent and the curing agent are respectively weighed and mixed to prepare a liquid mixture immediately before use. The liquid mixture is applied to one resin plate to form a coating film, and the one resin plate and the other resin plate are adhered to each other via the coating film.

Thereafter, in the coating film, the main agent and the curing agent react with each other and the main agent is cured, thereby firmly adhering the two resin plates.

In addition, Patent Literature 2 below discloses an adhesive sheet set including a first adhesive sheet and a second adhesive sheet, in which the first adhesive sheet includes a first release liner and a first adhesive layer provided on one surface of the first release liner, the second adhesive sheet includes a second release liner and a second adhesive layer provided on one surface of the second release liner, and the first adhesive sheet and the second adhesive sheet are cured and adhered to each other when the first adhesive layer and the second adhesive layer are brought into contact each other.

Further, Patent Literature 3 below discloses an adhesion method including a step (1) of disposing an adhesive layer on a first adherend, a step (2) of disposing, on a second adherend, a curing agent layer capable of curing the adhesive layer by contact and a reaction with the adhesive layer, and a step (3) of bringing the adhesive layer and the curing agent layer into contact with each other to sandwich the adhesive layer and the curing agent layer between the first adherend and the second adherend.

### CITATION LIST

### Patent Literature

Patent Literature 1: JP2000-336333A

Patent Literature 2: WO2017/061625

Patent Literature 3: JP2017-88723A

### SUMMARY OF INVENTION

### Technical Problem

However, in an adhesion method using the two-component adhesive agent described in Patent Literature 1, it is necessary to respectively weigh and mix the main agent and the curing agent, immediately before use. Therefore, there is a problem that the steps are complicated.

In addition, the adhesive sheet set described in Patent Literature 2 has a slow curing speed and has a problem in workability.

Further, the adhesion method described in Patent Literature 3 has problems that adhesive strength after curing is low and toughness required for a sheet is poor. Further, Patent Literature 3 does not describe an adhesive kit that can be cured at room temperature in a short time as in the present invention.

Therefore, an object of the present invention is to provide an adhesive kit, an adhesion method, and an adhered structure that do not require complicated steps, can be cured at room temperature in a short time, and have excellent adhesive strength after curing.

### Solution to Problem

The present invention is as follows.
1. An adhesive kit including:
an adhesive layer containing an epoxy resin and an elastomer; and
a curing agent liquid composition capable of curing the adhesive layer by contact and a reaction with the adhesive layer, in which
the adhesive layer contains 1 mass % to 30 mass % of the elastomer.
2. The adhesive kit according to the above 1, in which the elastomer is dispersed in the adhesive layer.
3. The adhesive kit according to the above 1 or 2, in which the elastomer is elastomer fine particles having an average particle diameter of 0.05 μm or more and 0.5 μm or less.
4. The adhesive kit according to the above 1 or 2, in which the elastomer is a block polymer containing a block body compatible with the epoxy resin and a block body incompatible with the epoxy resin.
5. The adhesive kit according to any one of the above 1 to 4, in which the adhesive layer has a thickness of 3 μm or more and 100 μm or less.
6. The adhesive kit according to any one of the above 1 to 5, in which the adhesive layer has an elastic modulus of 1.0×10⁸ Pa or more at room temperature (25° C.) 24 hours after start of curing.
7. The adhesive kit according to any one of the above 1 to 5, in which the adhesive layer has an elastic modulus of 5.0×10⁸ Pa or more at room temperature (25° C.) 24 hours after start of curing.
8. The adhesive kit according to any one of the above 1 to 7, in which the adhesive layer has a shear adhesive force of 10 MPa or more after curing.
9. An adhesion method including:

providing an adhesive layer and a curing agent liquid composition between a first adherend and a second adherend; and
adhering the first adherend and the second adherend to each other, in which
the adhesive layer contains an epoxy resin and an elastomer, and
the adhesive layer contains 1 mass % to 30 mass % of the elastomer.
10. The adhesion method according to the above 9, including:
a step (1) of disposing the adhesive layer on the first adherend;
a step (2) of providing the second adherend with the curing agent liquid composition capable of curing the adhesive layer by contact and a reaction with the adhesive layer; and
a step (3) of bringing the adhesive layer and the curing agent liquid composition into contact with each other to sandwich the adhesive layer and the curing agent liquid composition between the first adherend and the second adherend.
11. The adhesion method according to the above 9, including:
a step (11) of disposing the adhesive layer on the first adherend;
a step (12) of providing the adhesive layer with the curing agent liquid composition capable of curing the adhesive layer by contact and a reaction with the adhesive layer; and
a step (13) of disposing the second adherend on the adhesive layer.
12. An adhered structure including:
a first adherend;
a second adherend disposed to face the first adherend; and
a cured layer sandwiched between the first adherend and the second adherend, wherein
the cured layer is a cured layer obtained by a reaction between an adhesive layer and a curing agent liquid composition,
the adhesive layer contains an epoxy resin and an elastomer, and
the adhesive layer contains 1 mass % to 30 mass % of the elastomer.

### Advantageous Effects of Invention

According to the present invention, it is possible to provide an adhesive kit, an adhesion method, and an adhered structure that do not require complicated steps, can be cured at room temperature in a short time, and have excellent adhesive strength after curing.

### BRIEF DESCRIPTION OF DRAWINGS

(a) in FIG. 1 and (b) in FIG. 1 are process diagrams illustrating an adhesion method according to one embodiment of the present invention, in which (a) in FIG. 1 shows a step (1) of disposing an adhesive layer on a first adherend, and a step (2) of disposing a curing agent liquid composition on a second adherend, and b) in FIG. 1 shows a step (3) of bringing the adhesive layer and the curing agent liquid composition into contact with each other to sandwich the adhesive layer and the curing agent liquid composition between the first adherend and the second adherend.

FIG. 2 is a diagram illustrating an embodiment in which the adhesive layer is provided with a substrate layer.

### DESCRIPTION OF EMBODIMENTS

Hereinafter, embodiments of the present invention will be described.

An adhesive kit according to one embodiment of the present invention includes: an adhesive layer containing an epoxy resin and an elastomer; and a curing agent liquid composition capable of curing the adhesive layer by contact and a reaction with the adhesive layer, in which the adhesive layer contains 1 mass % to 30 mass % of the elastomer.

Examples of the epoxy resin for use in the adhesive layer include bisphenol-based epoxy resins such as a bisphenol A epoxy resin, a bisphenol F epoxy resin, a bisphenol S epoxy resin, and a hydrogenated bisphenol A epoxy resin, a naphthalene epoxy resin, a biphenyl epoxy resin, a dicyclo epoxy resin, an alicyclic epoxy resin, a triglycidyl isocyanurate epoxy resin, a hydantoin epoxy resin, a glycidyl ether-based epoxy resin, and a glycidylamino-based epoxy resin.

In addition, as the epoxy resin, a trifunctional or higher multifunctional epoxy resin can also be used. Examples of such a multifunctional epoxy resin include a phenol novolac type epoxy resin, an orthocresol novolac type epoxy resin, a triphenyl novolac type epoxy resin, a bisphenol A novolac type epoxy resin, and an aliphatic epoxy resin.

The epoxy resin is preferably a bisphenol-based epoxy resin, and more preferably a bisphenol A epoxy resin.

The epoxy resin can be used alone or in combination of two or more types thereof.

Note that in the case of using a multifunctional epoxy resin, it is preferably 1 mass % to 50 mass %, and more preferably 3 mass % to 30 mass %, based on the entire epoxy resin.

The epoxy resin may be in any of liquid, semi-solid and solid forms at room temperature, and more preferred examples thereof include a semi-solid epoxy resin used alone, and a liquid epoxy resin and a solid epoxy resin used in combination. Accordingly, a tacky layered adhesive layer can be reliably formed from an adhesive composition.

The liquid epoxy resin at room temperature is specifically a liquid at 25° C. The viscosity of the liquid epoxy resin at 25° C. is, for example, 30 Pa·s or more, preferably 80 Pa·s or more, and is, for example, 500 Pa·s or less, preferably 300 Pa·s or less.

The solid epoxy resin at room temperature is specifically a solid at 25° C. The softening point of the solid epoxy resin is, for example, 70° C. or higher, and preferably 75° C. or higher.

In the case of using the liquid epoxy resin and the solid epoxy resin in combination, a blending ratio of the liquid epoxy resin to the solid epoxy resin (liquid epoxy resin/solid epoxy resin) is, for example, 1.0 or more, preferably 1.5 or more, and is, for example, 4.0 or less, preferably 3.0 or less.

When the blending ratio of the liquid epoxy resin to the solid epoxy resin is equal to or greater than the above lower limit, the viscosity of the adhesive composition is reduced, the unevenness of a coating film can be prevented, and a uniform adhesive layer can be obtained. When the blending ratio of the liquid epoxy resin to the solid epoxy resin is equal to or smaller than the above upper limit, a tacky layered adhesive layer can be obtained.

The content of the epoxy resin in the adhesive layer is preferably 30 mass % to 99 mass %, and more preferably 50 mass % to 90 mass %.

The composition of the elastomer for use in the adhesive layer can be appropriately selected from known elastomer materials. Examples thereof include a butadiene rubber, an acrylic rubber, a silicone rubber, a butyl rubber, an acrylonitrile-butadiene rubber (NBR), and a styrene-butadiene copolymer rubber (SBR). The elastomer may or may not be terminally modified.

From the viewpoint of improving the effects of the present invention, especially from the viewpoint of not reducing the curing speed, improving toughness, and having excellent heat resistance, the elastomer is preferably dispersed in the adhesive layer. From the viewpoint of being dispersed in the adhesive layer, the elastomer is preferably elastomer fine particles or a block polymer.

The elastomer fine particles may be particles made of only one layer of the above elastomer material, or may be particles with a multilayer structure.

From the viewpoint of dispersibility, as the elastomer fine particles, those have been previously dispersed in an epoxy resin may be used.

The average particle diameter of the elastomer fine particles is preferably 0.05 μm or more and 0.5 μm or less. When this average particle diameter condition is satisfied, the elastomer can be easily dispersed in the epoxy resin, and the effects of the present invention can be further enhanced. The average particle diameter of the elastomer fine particles is more preferably 0.3 μm or less.

The average particle diameter in the present description means a value measured by observation using a scanning electron microscope (SEM) or a transmission electron microscope (TEM).

The block polymer preferably contains a block body compatible with the epoxy resin and a block body incompatible with the epoxy resin. It is thought that the block body incompatible with the epoxy resin undergoes phase separation due to self-organization in the adhesive layer, forming a finely dispersed structure. As the block polymer, an acrylic block polymer composed of an alkyl (meth) acrylate monomer unit is preferred.

Among them, a diblock polymer and a triblock polymer are preferred as the acrylic block polymer in the present embodiment. Particularly, a diblock polymer composed of methacrylate-acrylate or a triblock polymer composed of methacrylate-acrylate-methacrylate is preferred, and a triblock polymer composed of methacrylate-acrylate-methacrylate is preferred.

The adhesive layer in the adhesive kit according to the embodiment of the present invention needs to contain 1 mass % to 30 mass % of the elastomer. When the content of the elastomer is 1 mass % or more, the adhesive strength after curing is increased, and satisfactory toughness required for the sheet can be obtained. When the content of the elastomer is 30 mass % or less, a sheet having a sufficient elastic modulus as required can be obtained.

The content of the elastomer is preferably 1 mass % to 30 mass %, and more preferably 3 mass % to 25 mass %. In addition, the content of the elastomer may be 20 mass % or less, 15 mass % or less, or 12 mass % or less.

The thickness of an adhesive layer 1 is, for example, 3 μm or more, preferably 5 μm or more, more preferably 10 μm or more, and is, for example, 100 μm or less, preferably 90 μm or less, more preferably 75 μm or less.

When the thickness of the adhesive layer 1 is 3 μm or more, it is advantageous in that the peeling force before curing and the impact resistance after curing are excellent.

In addition, when the thickness of the adhesive layer 1 is 100 μm or less, it is advantageous in that the curing agent liquid composition described below easily permeates the adhesive layer 1, thereby improving the curing speed.

Note that, the curing agent liquid composition will be described in detail in the section below describing an adhesion method according to one embodiment of the present invention.

Next, the adhesion method according to the embodiment of the present invention will be described.

The adhesion method according to the embodiment of the present invention includes a step of providing an adhesive layer and a curing agent liquid composition between a first adherend and a second adherend, and adhering the first adherend and the second adherend to each other.

A specific form (i) includes: a step (1) of disposing an adhesive layer containing an epoxy resin and an elastomer on a first adherend; a step (2) of disposing, on a second adherend, a curing agent liquid composition capable of curing the adhesive layer by contact and a reaction with the adhesive layer; and a step (3) of bringing the adhesive layer and the curing agent liquid composition into contact with each other to sandwich the adhesive layer and the curing agent liquid composition between the first adherend and the second adherend.

Another specific form (ii) includes: a step (11) of disposing an adhesive layer containing an epoxy resin and an elastomer on a first adherend; a step (12) of providing the adhesive layer with a curing agent liquid composition capable of curing the adhesive layer by contact and a reaction with the adhesive layer; and a step (13) of disposing a second adherend on the adhesive layer.

Here, as described above, the adhesive layer needs to contain 1 mass % to 30 mass % of the elastomer.

The adhesion method according to the embodiment of the present invention will be described in detail.

The adhesion method in the form (i) includes: a step (1) of disposing the adhesive layer 1 on a first adherend 2 (see (a) in FIG. 1); a step (2) of disposing, on a second adherend 4, a curing agent liquid composition 3 capable of curing the adhesive layer 1 by contact and a reaction with the adhesive layer 1 (see (a) in FIG. 1); and a step (3) of bringing the adhesive layer 1 and the curing agent liquid composition 3 into contact with each other to sandwich the adhesive layer 1 and the curing agent liquid composition 3 between the first adherend 2 and the second adherend 4 (see (b) in FIG. 1).

Hereinafter, each step will be described.

### Step (1)

In the step (1), as shown in (a) in FIG. 1, the adhesive layer 1 is disposed on the first adherend 2.

When being brought into contact and reacting with the curing agent liquid composition 3, the adhesive layer 1 is a cured layer (sheet), extends along the surface direction (direction perpendicular to the thickness direction), and has a substantially flat plate shape having a flat front surface and back surface.

In order to dispose the adhesive layer 1 on the first adherend 2, for example, the adhesive layer 1 is first formed on the surface of a release liner 10.

In order to form the adhesive layer 1 on the surface of the release liner 10, first, an adhesive composition is prepared.

As described above, the adhesive composition contains an epoxy resin as a main component and also contains an elastomer.

A small amount of a curing agent can also be added to the adhesive composition. Accordingly, the cohesive force of the adhesive layer 1 can be improved.

Examples of the curing agent are given below.

A blending proportion of the curing agent is adjusted to a ratio for improving the peel adhesive force of the adhesive layer 1 while slightly curing (not completely curing) the adhesive composition.

Specifically, the blending proportion of the curing agent is, for example, 0.05 parts by mass or more, preferably 0.15 parts by mass or more, and is, for example, 5 parts by mass or less, preferably 3 parts by mass or less, based on 100 parts by mass of the epoxy resin.

In addition, when the curing agent is an imidazole compound described below, the blending proportion of the curing agent is, for example, 0.05 parts by mass or more, preferably 0.15 parts by mass or more, and is, for example, 5 parts by mass or less, preferably 3 parts by mass or less, based on 100 parts by mass of the epoxy resin.

In addition, when the curing agent is an amine compound described below, specifically, the blending proportion is, for example, 30 parts by mass or less, preferably 15 parts by mass or less, and more preferably 10 parts by mass or less, based on 100 parts by mass of the epoxy resin.

When the blending proportion of the curing agent is equal to or greater than the above lower limit, the peel adhesive force of the adhesive layer 1 can be improved. When the blending proportion of the curing agent is equal to or smaller than the above upper limit, complete curing of the adhesive layer 1 can be prevented, a decrease in reactivity between the adhesive layer 1 and the curing agent liquid composition 3 can be prevented, and a cured layer 5 described below can be reliably formed.

The adhesive composition may be obtained by, for example, blending an epoxy resin, an elastomer, and, if necessary, a curing agent. In order to form the adhesive layer on the surface of the release liner 10, if necessary, the adhesive composition is diluted with a solvent to prepare a varnish. The solvent may be any solvent as long as it can dissolve the adhesive composition, and examples thereof include the above solvents, and preferably a ketone-based solvent.

The concentration of the adhesive composition in the varnish is, for example, 20 mass % or more, preferably 40 mass % or more, and is, for example, 80 mass % or less, preferably 70 mass % or less.

In addition, when the adhesive composition contains an acrylic block polymer, a crosslinking agent can also be blended in preparing the adhesive composition.

Examples of the crosslinking agent include an isocyanate-based crosslinking agent, an aziridine-based crosslinking agent, an epoxy-based crosslinking agent, a metal chelate-based crosslinking agent, and preferably an isocyanate-based crosslinking agent.

Examples of the isocyanate-based crosslinking agent include aromatic diisocyanates such as tolylene diisocyanate and xylene diisocyanate, alicyclic diisocyanates such as isophorone diisocyanate, aliphatic diisocyanates such as hexamethylene diisocyanate, and a modified product of these isocyanates (specifically, a tolylene diisocyanate adduct of trimethylolpropane or the like).

The crosslinking agent is preferably a modified product of an isocyanate.

A blending proportion of the crosslinking agent is, for example, 1 part by mass or more, preferably 5 parts by mass or more, and is, for example, 20 parts by mass or less, preferably 15 parts by mass or less, based on 100 parts by mass of the acrylic block polymer.

Accordingly, the adhesive composition is prepared.

Thereafter, the adhesive composition is applied to the surface of the release liner 10, and then dried.

The release liner 10 is, for example, a release liner having a substantially flat plate shape, and has a flat upper surface and lower surface.

The release liner 10 is made of resin materials, for example, a polyolefin (specifically, polyethylene and polypropylene), a vinyl polymer such as an ethylene-vinyl acetate copolymer (EVA), a polyester such as polyethylene terephthalate or a polycarbonate, or a fluororesin such as polytetrafluoroethylene, and is therefore formed into a film. In addition, the release liner 10 can also be formed from, for example, a metal material such as iron, aluminum, or stainless steel.

The release liner 10 is preferably a polyester film, and more preferably a polyethylene terephthalate film.

Note that, the surface of the release liner 10 may be subjected to an appropriate peeling treatment, if necessary.

The thickness of the release liner 10 is, for example, 10 μm or more and 1000 μm or less.

Examples of the application method include a doctor blade method, a roll method, a screen method, a gravure method, and a spray method.

As for heating conditions, the heating temperature is, for example, 70° C. or higher and 130° C. or lower, and the heating time is, for example, 1 minute or longer and 5 minutes or shorter.

When the adhesive composition contains a crosslinking agent, the acrylic block polymer is crosslinked by the crosslinking agent by further heating after the heating described above. The temperature in the further heating is 30° C. or higher and 60° C. or lower, and the time is, for example, 1 hour or longer, and preferably 1 day or longer.

When the adhesive composition contains a curing agent, the heating temperature is 70° C. or higher and 160° C. or lower, and the heating time is 5 minutes or longer and 5 hours or shorter. Accordingly, all the curing agent reacts with a part of the epoxy resin.

Accordingly, the adhesive layer 1 is formed on the surface of the release liner 10.

In addition, if necessary, another release liner (not shown) can be disposed on (in contact with) the surface of the adhesive layer 1 (the surface opposite to the contact surface in contact with the release liner 10).

That is, the adhesive layer 1 can be sandwiched between two release liners.

Then, the adhesive layer 1 has pressure-sensitive adhesive properties (pressure-sensitive adhesiveness or initial adhesiveness).

Thereafter, the adhesive layer 1 is transferred from the release liner 10 to the surface of the first adherend 2. Specifically, first, the adhesive layer 1 is brought into contact with the first adherend 2, and subsequently, the release liner 10 is peeled from the adhesive layer 1, as shown by the arrow in (a) in FIG. 1.

The release liner 10 can also be peeled from the adhesive layer 1 after the step (2) and immediately before the step (3).

When the adhesive layer 1 is sandwiched between two release liners, for example, first, one release liner is peeled. Next, the exposed surface of the adhesive layer 1 is brought into contact with the first adherend 2, and subsequently, the release liner 10 is peeled from the adhesive layer 1, as shown by the arrow in (a) in FIG. 1.

The first adherend 2 is not particularly limited, and examples thereof include a metal, a glass, a plastic, a porous material such as a slate and a nonwoven fabric, mortar, concrete, a rubber, wood, leather, cloth, and paper.

The first adherend 2 is preferably a slate, mortar, or concrete.

Accordingly, as shown in (a) in FIG. 1, the adhesive layer 1 is disposed on the first adherend 2.

### Step (2)

The curing agent liquid composition 3 has a function of being capable of curing the adhesive layer 1 by contact and a reaction with the adhesive layer 1.

In the step (2), as shown in (a) in FIG. 1, the curing agent liquid composition 3 is disposed on the second adherend 4.

The curing agent liquid composition 3 contains a curing agent. Examples of the curing agent include epoxy resin curing agents such as an imidazole compound and an amine compound.

Examples of the imidazole compound include methylimidazole, 2-ethyl-4-methylimidazole, 1-isobutyl-2-methylimidazole (IBMI12), 1-benzyl-2-methylimidazole (1B2MZ), 1,2-dimethylimidazole (1,2DMZ), 1-butylimidazole (1BZ), 1-decyl-2-methylimidazole (1D2MZ), 1-octylimidazole (1 OZ), 2-ethyl-4-methylimidazole, ethylimidazole, isopropylimidazole, 2,4-dimethylimidazole (2E4MZ), 1-phenylimidazole (1PZ), undecylimidazole, heptadecylimidazole, 2-phenyl-4-methylimidazole, 2-phenyl-4,5-dihydroxymethylimidazole, and 2-phenyl-4-methyl-5-hydroxymethylimidazole. From the viewpoint of the curing speed, a 1-position substituted imidazole compound is preferred.

Examples of the amine compound include ethylenediamine, propylenediamine, diethylenetriamine, triethylenetetramine, an amine adduct thereof, metaphenylenediamine, diaminodiphenylmethane, and diaminodiphenylsulfone.

The curing agent is preferably a curing agent having catalytic activity with respect to the epoxy resin, and specific examples thereof include an imidazole compound.

The curing agent can be used alone or in combination of two or more types thereof.

The blending proportion of the curing agent is, for example, 10 mass % or more, preferably 30 mass % or more, more preferably 50 mass % or more, still more preferably 80mass % or more, particularly preferably 90 mass % or more, and is, for example, 100 mass % or less, based on the curing agent liquid composition. When the blending proportion of the curing agent is equal to or greater than the above lower limit, the adhesive layer 1 is excellent in adhesive properties.

The curing agent liquid composition is preferably composed of only a curing agent, that is, the proportion of the curing agent is preferably 100 mass % based on the curing agent liquid composition.

The curing agent liquid composition may contain the above epoxy resin, if necessary.

A blending proportion of the epoxy resin is, for example, 30 parts by mass or more, preferably 40 parts by mass or more, and is, for example, 70 parts by mass or less, preferably 60 parts by mass or less, based on 100 parts by mass of the curing agent.

When the blending proportion of the epoxy resin is equal to or smaller than the above upper limit, in the step (2), almost all the curing agent can be prevented from reacting with the epoxy resin in the curing agent liquid composition 3, and in the step (3), the reactivity of (the curing agent in) the curing agent liquid composition 3 with respect to (the epoxy resin in) the adhesive layer 1 can be prevented from decreasing.

In addition, a reaction diluent, a metal catalyst, or the like can be blended to the curing agent liquid composition if necessary.

Examples of the reaction diluent include glycidyl ether, which may be monofunctional or polyfunctional. Examples of the metal catalyst include organometallic compounds such as Al, Sn, Zr, Ti, Fe, Zn, and Bi.

A blending proportion of the reaction diluent is, for example, 1 part by mass or more, preferably 5 parts by mass or more, and is, for example, 80 parts by mass or less, preferably 50 parts by mass or less, based on 100 parts by mass of the curing agent.

A blending proportion of the metal catalyst is, for example, 0.01 parts by mass or more, preferably 0.1 parts by mass or more, and is, for example, 10 parts by mass or less, preferably 5 parts by mass or less, based on 100 parts by mass of the curing agent.

In order to prepare the curing agent liquid composition, a curing agent and, if necessary, an epoxy resin, a reaction diluent, a metal catalyst, or the like are blended to prepare a varnish.

When the curing agent is solid, the curing agent is dissolved in a solvent to prepare a varnish, if necessary. The solvent may be any solvent as long as it can dissolve the curing agent, and examples thereof include the above solvents.

The concentration of the curing agent liquid composition in the varnish is, for example, 10 mass % or more, preferably 20 mass % or more, and is, for example, 90 mass % or less, preferably 50 mass % or less.

Through the above, the curing agent liquid composition is prepared.

Thereafter, the curing agent liquid composition 3 is applied to the second adherend 4. The second adherend 4 is not particularly limited, and examples thereof include the above adherends. Examples of the application method include the above methods.

Accordingly, the curing agent liquid composition 3 is disposed on the second adherend 4.

Note that, in the present invention, the term “liquid” refers to one that exhibits fluidity at 25° C., and specifically refers to one having a viscosity in the range of 0.1 mPa·s to 100 mPa·s at 25° C.

The application amount of the curing agent liquid composition 3 is, for example, 0.1 g/m² to 100 g/m², and preferably 0.5 g/m² to 50 g/m².

### Step (3)

In the step (3), as shown in (b) in FIG. 1, the adhesive layer 1 and the curing agent liquid composition 3 are brought into contact with each other to be sandwiched between the first adherend 2 and the second adherend 4.

That is, the first adherend 2 and the second adherend 4 are overlapped such that the adhesive layer 1 and the curing agent liquid composition 3 are in contact with each other.

Then, the adhesive layer 1 and the curing agent liquid composition 3 come into contact with each other and react with each other due to the action of the curing agent. The action of the curing agent includes, for example, the action of the curing agent permeating the adhesive layer 1.

The reaction temperature is, for example, room temperature.

In addition, if necessary, the adhesive layer 1 and the curing agent liquid composition 3 may be heated. The heating temperature is, for example, 50° C. or higher, preferably 70° C. or higher, and is, for example, 130° C. or lower, preferably 110° C. or lower.

The reaction temperature is preferably room temperature. Room temperature is a temperature at which the above heating (for example, heating at 50° C. or higher) for causing the adhesive layer 1 and the curing agent liquid composition 3 to react with each other is not performed, and is, for example, lower than 50° C., preferably 40° C. or lower, and is, for example, 10° C. or higher, preferably 20° C. or higher.

When the reaction temperature is room temperature, the first adherend 2 and the second adherend 4 can be adhered to each other even more easily without the need of heating for causing the adhesive layer 1 and the curing agent liquid composition 3 to react with each other.

The reaction time is, for example, 1 hour or longer, preferably 12 hours or longer, and is, for example, 96 hours or shorter, preferably 48 hours or shorter.

Accordingly, the adhesive layer 1 is cured to form the cured layer 5. Preferably, the adhesive layer 1 is cured at room temperature.

Note that, although a boundary is formed between the adhesive layer 1 and the curing agent liquid composition 3 in (b) in FIG. 1, the cured layer 5 is a layer in which the adhesive layer 1 and the curing agent liquid composition 3 are integrated and reacted with each other, and the above boundary is not present.

The first adherend 2 and the second adherend 4 are adhered to each other by this cured layer 5.

In the embodiment of the present invention, the adhesive layer preferably has an elastic modulus of 1.0×10⁸ Pa or more at room temperature (25° C.) 24 hours after start of curing. When this condition is satisfied, it can be said that good curing is possible at room temperature in a short time. The elastic modulus is more preferably 5.0×10⁸ Pa or more.

The elastic modulus is a value measured by the method described in Examples.

In the embodiment of the present invention, the adhesive layer preferably has an elastic modulus of 5.0×10⁸ Pa or more at room temperature (25° C.) 72 hours after start of curing.

In addition, in the embodiment of the present invention, the adhesive layer preferably has a shear adhesive force of 10 MPa or more after curing. When this condition is satisfied, it can be said that the adhesive force is increased, and the toughness of the sheet is also improved. The shear adhesive force is more preferably 11 MPa or more.

The shear adhesive force is a value measured by the method described in Examples.

Accordingly, an adhered structure 6 is produced.

That is, the adhered structure 6 includes the first adherend 2, the second adherend 4 disposed to face the first adherend 2, and the cured layer 5 sandwiched therebetween.

In the adhered structure 6, the first adherend and the second adherend are firmly adhered to each other by the cured layer 5.

Next, the form (ii) will be described. The form (ii) includes: a step (11) of disposing an adhesive layer containing an epoxy resin and an elastomer on a first adherend; a step (12) of providing the adhesive layer with a curing agent liquid composition capable of curing the adhesive layer by contact and a reaction with the adhesive layer; and a step (13) of disposing a second adherend on the adhesive layer.

That is, the adhesive layer is disposed on the first adherend, the adhesive layer is provided with the curing agent liquid composition capable of curing the adhesive layer by a reaction with adhesive layer, and then the second adherend is disposed thereon.

The form (ii) is the same as the embodiment in the form (i), and the preferred form is also the same, except that the curing agent liquid composition is provided not on the second adherend but on the adhesive layer.

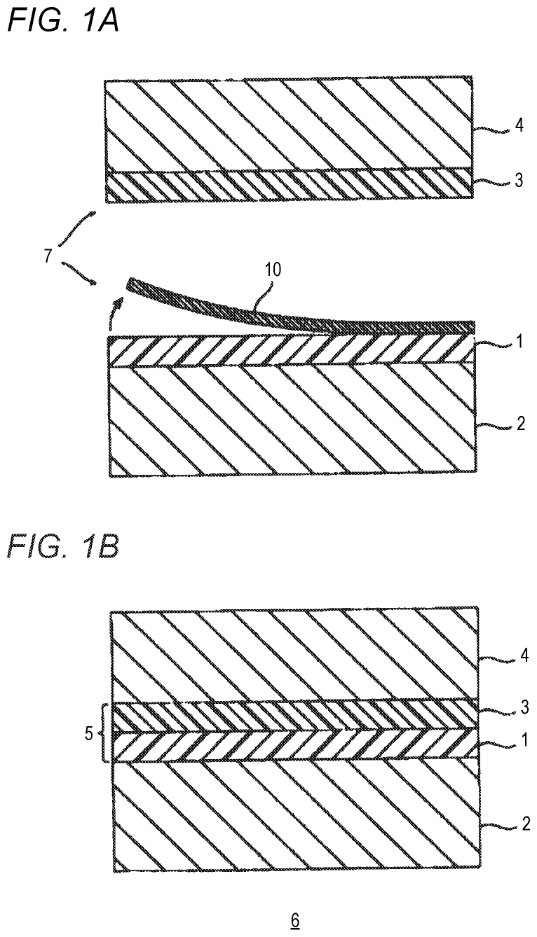

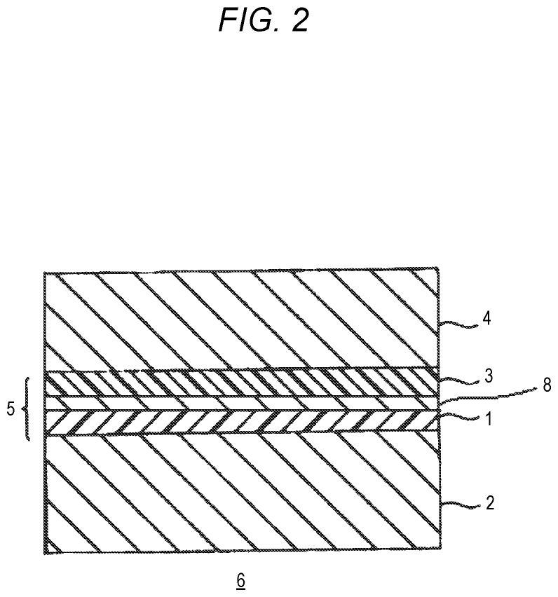

Note that, the cured layer 5 may include a substrate layer 8 provided in the center of the adhesive layer 1 in the thickness direction, as shown in FIG. 2. Examples of the material for the substrate layer 8 include a foam sheet, a nonwoven fabric, and a porous sheet such as slate. The thickness of the substrate layer 8 is appropriately set depending on the first adherend 2 and the second adherend 4, and is not particularly limited. For example, it is 50 μm or more, preferably 100 μm or more, and is, for example, 8 mm or less, preferably 5 mm or less.

### EXAMPLE

Hereinafter, Examples and Comparative Examples are shown to further specifically describe the present invention. Note that, the present invention is not limited to Examples and Comparative Examples in any way. In addition, specific numerical values such as blending proportions (content proportions), physical property values, or parameters used in the following description can be replaced with the upper limit values (numerical values defined as “or less” or “less than”) or the lower limit values (numerical values defined as “or more” or “less than”) of the corresponding blending proportions (content proportions), physical property values, or parameters described in the above “DESCRIPTION OF EMBODIMENTS”. Further, “liquid” and “solid” mean properties at room temperature (25° C.).

Note that, “part” and “%” are based on mass unless otherwise stated.

### Examples 1 to 11 and Comparative Examples 1 to 5

The following materials were used as the epoxy resin.
Liquid bisphenol A epoxy resin (product name “jER828”, manufactured by Mitsubishi Chemical Corporation) ⋅Liquid multifunctional phenol novolac type epoxy resin (product name “jER152”, manufactured by Mitsubishi Chemical Corporation) ⋅Solid bisphenol A epoxy resin (product name “jER1256”, manufactured by Mitsubishi Chemical Corporation) ⋅Solid bisphenol A epoxy resin (product name “jER1001”, manufactured by Mitsubishi Chemical Corporation)

In addition, the following materials were used as the epoxy resin containing an elastomer.
Polybutadiene rubber particle-dispersed bisphenol A epoxy resin (product name: “Kane Ace MX-154”, manufactured by KANEKA CORPORATION, polybutadiene rubber particles: 40 mass %, average particle diameter=100 nm to 200 nm)
Acrylic rubber particle-dispersed bisphenol A epoxy resin (product name: “ACRYSET BPA 328”, manufactured by NIPPON SHOKUBAI CO., LTD., acrylic rubber particles: 20 mass %, average particle diameter=200 nm to 300 nm)

Further, the following materials were used as the elastomer.
Acrylic block polymer fine particles (product name: “Nanostrength M52N”, manufactured by ARKEMA)

Note that, the above acrylic block polymer fine particles are a poly(methyl methacrylate)/poly(butyl acrylate)/poly(methyl methacrylate) terpolymer and correspond to a triblock polymer. Here, poly(methyl methacrylate) is a block body compatible with the epoxy resin, and poly(butyl acrylate) is a block body not compatible with the epoxy resin.

The above materials were mixed in the proportions shown in Table 1 below to prepare an adhesive composition, and methyl ethyl ketone was added to dilute the epoxy resin to a concentration of 60%, to prepare a varnish. The varnish was applied on a surface of a polyethylene terephthalate film (PET film) (product name: “DIAFOIL MRF #38”, manufactured by Mitsubishi Chemical Corporation) that had subjected to a peeling treatment, and dried by heating at 80° C. for 3 minutes such that the thickness after drying was the value shown in Table 1, to form various adhesive layers. Thereafter, the adhesive layer was brought into contact with another polyethylene terephthalate film such that the adhesive layer was sandwiched between the two polyethylene terephthalate films to obtain a sheet. Note that, since methyl ethyl ketone is removed by the above heating and drying treatment, the blending proportion of each material in formed the adhesive layer is as shown in Table 1.

As the curing agent in the curing agent liquid composition, the curing agents shown in Table 1 below were used. Note that ethanol was used for dilution. The curing agent liquid composition is liquid at room temperature.

In addition, the curing agent (sheet) used in Comparative Example 5 was prepared as follows. That is, the materials shown in Table 1 below were diluted by adding methyl ethyl ketone to have a concentration of 50 mass %, to prepare a varnish. Note that, as the acrylic block polymer, product name: “Nanostrength M52N”, manufactured by ARKEMA was used. The varnish was applied on a surface of a polyethylene terephthalate film (PET film) (product name: “DIAFOIL MRF #38”, manufactured by Mitsubishi Chemical Corporation) that had subjected to a peeling treatment, and dried by heating at 80° C. for 3 minutes such that the thickness after drying was the value shown in Table 1, to form a curing agent (sheet).

Thereafter, the curing agent (sheet) was brought into contact with another polyethylene terephthalate film such that the curing agent (sheet) was sandwiched between the two polyethylene terephthalate films to obtain a sheet. Note that, since methyl ethyl ketone is removed by the above heating and drying treatment, the blending proportion of each material in the formed curing agent (sheet) is as shown in Table 1.

Subsequently, one of the PET films in the sheet was peeled, and a curing agent liquid composition was applied using a wire bar in the application amount shown in Table 1 below, and a reaction was carried out at room temperature (25° C.) to cure the adhesive layer. Next, the other PET film in the sheet was peeled, the sheet was cut into 10 mm in width×40 mm in length after curing for 24 hours or after curing for 72 hours, and a tensile test was conducted at a distance between chucks of 10 mm and a tensile speed of 50 mm/min. The initial tensile modulus (Pa) after curing was determined from a slope of the first part (tangential line) of the obtained stress-strain curve. The elastic modulus in the present description is a value measured by the test method.

The shear adhesive force was measured according to the following method.

The adhesive layer prepared as above was cut into a size of 20 mm in width×10 mm in length, then one of the polyethylene terephthalate films was peeled, and the tip of a first SS400 steel plate (no black skin) having 20 mm in width×80 mm in length×2.3 mm in thickness was disposed on the exposed adhesive layer. Next, the other polyethylene terephthalate film was peeled.

Next, a curing agent liquid composition was applied to the adhesive layer, or the curing agent (sheet) was attached thereto. When the curing agent liquid composition was applied to the adhesive layer, excess liquid on the surface was wiped off. Immediately after applying the curing agent liquid composition or attaching the curing agent (sheet), the tip of a second SS400 steel plate (no black scale) having 20 mm in width×80 mm in length×2.3 mm in thickness was brought into contact with the adhesive layer side coated with the curing agent liquid composition or attached with the curing agent (sheet), whereby the two SS400 steel plates were adhered to each other, and then the two SS400 steel plates were fixed with clips and left at room temperature for 72 hours. Accordingly, a structure was obtained in which two SS400 steel plates were joined by a cured layer formed by a reaction between an adhesive layer and a curing agent liquid composition or a curing agent (sheet).

Thereafter, two SS400 steel plates were pulled in the shear direction (length direction) at a peeling speed of 5 mm/min using a tensile compression testing machine (device name “AG-X”, manufactured by Shimadzu Corporation), and the test force when one of the two SS400steel plates was peeled was measured. The shear adhesive force was calculated using the following formula. The shear adhesive force in the present description is a value measured by the test method.

$$Shear adhesive force ( MPa ) = test force ( N ) / 200 {mm}^{2} \qquad ( 1 )$$

The results are shown in Table 1. Note that, in Example 1 in Table 1, 7.6.E+08 means 7.6×10⁸. The same applies to other examples.

TABLE 1

| | | | | Example 1 | Example 2 | Example 3 | Example 4 | Example 5 | Example 6 |
|---|---|---|---|---|---|---|---|---|---|
| Configuration | | | | Sheet/liquid | Sheet/liquid | Sheet/liquid | Sheet/liquid | Sheet/liquid | Sheet/liquid |
| (form of adhesive layer/ | | | | | | | | | |
| form of curing agent) | | | | | | | | | |
| Adhesive | Thickness (μm) | | | 50 | 50 | 50 | 50 | 50 | 50 |
| layer | Composition | Epoxy | jER828 | 25 | — | 47.5 | 42.5 | — | — |
| (sheet) | (mass %) | resin | (liquid BisA) | | | | | | |
| | | Elastomer- | KANE ACE | 25 | 50 | 2.5 | 7.5 | 75 | — |
| | | containing | MX154 (liquid | | | | | | |
| | | epoxy | polybutadiene | | | | | | |
| | | resin | rubber | | | | | | |
| | | | particle- | | | | | | |
| | | | dispersed | | | | | | |
| | | | BisA: 40 | | | | | | |
| | | | mass %) | | | | | | |
| | | | ACRYSET | — | — | — | — | — | 50 |
| | | | BPA328 | | | | | | |
| | | | (liquid | | | | | | |
| | | | acrylic | | | | | | |
| | | | rubber | | | | | | |
| | | | particle | | | | | | |
| | | | dispersed- | | | | | | |
| | | | BisA: 20 | | | | | | |
| | | | mass %) | | | | | | |
| | | Epoxy | jER152 | 20 | 20 | 20 | 20 | — | 20 |
| | | resin | (liquid | | | | | | |
| | | | multi- | | | | | | |
| | | | functional) | | | | | | |
| | | | jER1256 | 30 | 30 | 30 | 30 | 25 | 30 |
| | | | (solid | | | | | | |
| | | | BisA) | | | | | | |
| | | | jER1001 | — | — | — | — | — | — |
| | | | (solid BisA) | | | | | | |
| | | Elastomer | Acrylic | — | — | — | — | — | — |
| | | | block | | | | | | |
| | | | polymer | | | | | | |
| | | Elastomer content | | 10 | 20 | 1 | 3 | 30 | 10 |
| Curing | Application amount (g/m²) | | | 10.4 | 10.4 | 10.4 | 10.4 | 10.4 | 10.4 |
| agent liquid | Composition | Curing | 1,2-DMZ | 80 | 80 | 80 | 80 | 80 | 80 |
| composition | (mass %) | agent | (imidazole) | | | | | | |
| | | Solvent | EtOH | 20 | 20 | 20 | 20 | 20 | 20 |
| Curing | Thickness (μm) | | | | | | | | |
| agent | Composition | Elastomer | Acrylic block | | | | | | |
| (sheet) | (part by | | polymer | | | | | | |
| | mass) | Curing | 1,2-DMZ | | | | | | |
| | | agent | (imidazole) | | | | | | |
| Physical | Shear | Room temperature, | | 14.1 | 16.4 | 13.1 | 15.1 | 16.1 | 14.9 |
| properties | adhesive | 72 h after | | | | | | | |
| | force (Mpa) | | | | | | | | |
| | Elastic | 24 h after | | 7.6.E+08 | 6.6.E+08 | 8.6.E+08 | 6.8.E+08 | 5.0.E+08 | 6.5.E+08 |
| | modulus | | | | | | | | |
| | (Pa) after | 72 h after | | 8.3.E+08 | 7.1.E+08 | 8.1.E+08 | 9.2.E+08 | 6.6.E+08 | 8.6.E+08 |
| | curing | | | | | | | | |

| | | | | Example 7 | Example 8 | Example 9 | Example 10 | Example 11 |
|---|---|---|---|---|---|---|---|---|
| Configuration | | | | Sheet/liquid | Sheet/liquid | Sheet/liquid | Sheet/liquid | Sheet/liquid |
| (form of adhesive layer/ | | | | | | | | |
| form of curing agent) | | | | | | | | |
| Adhesive | Thickness (μm) | | | 50 | 50 | 50 | 50 | 50 |
| layer | Composition | Epoxy | jER828 | 45 | 25 | 40 | 30 | 20 |
| (sheet) | (mass %) | resin | (liquid BisA) | | | | | |
| | | Elastomer- | KANE ACE | — | — | — | — | — |
| | | containing | MX154 | | | | | |
| | | epoxy | (liquid | | | | | |
| | | resin | polybutadiene | | | | | |
| | | | rubber | | | | | |
| | | | particle- | | | | | |
| | | | dispersed | | | | | |
| | | | BisA: 40 | | | | | |
| | | | mass %) | | | | | |
| | | | ACRYSET | 5 | 25 | — | — | — |
| | | | BPA328 | | | | | |
| | | | (liquid | | | | | |
| | | | acrylic | | | | | |
| | | | rubber | | | | | |
| | | | particle | | | | | |
| | | | dispersed- | | | | | |
| | | | BisA: 20 | | | | | |
| | | | mass %) | | | | | |
| | | Epoxy | jER152 | 20 | 20 | 20 | 20 | 20 |
| | | resin | (liquid | | | | | |
| | | | multi- | | | | | |
| | | | functional) | | | | | |
| | | | jER1256 | 30 | 30 | 30 | 30 | 30 |
| | | | (solid BisA) | | | | | |
| | | | jER1001 | — | — | — | — | — |
| | | | (solid BisA) | | | | | |
| | | Elastomer | Acrylic | — | — | 10 | 20 | 30 |
| | | | block | | | | | |
| | | | polymer | | | | | |
| | | Elastomer content | | 1 | 5 | 10 | 20 | 30 |
| Curing | Application amount (g/m²) | | | 10.4 | 10.4 | 10.4 | 10.4 | 10.4 |
| agent | Composition | Curing | 1,2-DMZ | 80 | 80 | 80 | 80 | 80 |
| liquid | (mass %) | agent | (imidazole) | | | | | |
| composition | | Solvent | EtOH | 20 | 20 | 20 | 20 | 20 |
| Curing | Thickness (μm) | | | | | | | |
| agent | Composition | Elastomer | Acrylic block | | | | | |
| (sheet) | (part by | | polymer | | | | | |
| | mass) | Curing | 1,2-DMZ | | | | | |
| | | agent | (imidazole) | | | | | |
| Physical | Shear | Room temperature, | | 11.6 | 14.1 | 11.3 | 13.6 | 10.9 |
| properties | adhesive | 72 h after | | | | | | |
| | force (Mpa) | | | | | | | |
| | Elastic | 24 h after | | 6.1.E+08 | 5.4.E+08 | 1.9.E+08 | 1.9.E+08 | 3.3.E+08 |
| | modulus | | | | | | | |
| | (Pa) after | 72 h after | | 8.0.E+08 | 7.8.E+08 | 8.3.E+08 | 6.1.E+08 | 6.1.E+08 |
| | curing | | | | | | | |
| | | | | Comparative | Comparative | Comparative | Comparative | Comparative |
| | | | | Example 1 | Example 2 | Example 3 | Example 4 | Example 5 |
| Configuration | | | | Sheet/liquid | Sheet/liquid | Sheet/liquid | Sheet/liquid | Sheet/sheet |
| (form of adhesive layer/ | | | | | | | | |
| form of curing agent) | | | | | | | | |
| Adhesive | Thickness (μm) | | | 50 | 50 | 50 | 50 | 75 |
| layer | Composition | Epoxy | jER828 | 50 | 48.75 | 49.5 | 10 | 57 |
| (sheet) | (mass %) | resin | (liquid BisA) | | | | | |
| | | Elastomer- | KANE ACE | — | 1.25 | — | — | — |
| | | containing | MX154 | | | | | |
| | | epoxy | (liquid | | | | | |
| | | resin | polybutadiene | | | | | |
| | | | rubber | | | | | |
| | | | particle- | | | | | |
| | | | dispersed | | | | | |
| | | | BisA: 40 | | | | | |
| | | | mass %) | | | | | |
| | | | ACRYSET | — | — | — | — | — |
| | | | BPA328 | | | | | |
| | | | (liquid | | | | | |
| | | | acrylic | | | | | |
| | | | rubber | | | | | |
| | | | particle | | | | | |
| | | | dispersed- | | | | | |
| | | | BisA: 20 | | | | | |
| | | | mass %) | | | | | |
| | | Epoxy | jER152 | 20 | 20 | 20 | 20 | — |
| | | resin | (liquid | | | | | |
| | | | multi- | | | | | |
| | | | functional) | | | | | |
| | | | jER1256 | 30 | 30 | 30 | 30 | — |
| | | | (solid BisA) | | | | | |
| | | | jER1001 | — | — | — | — | 30 |
| | | | (solid BisA) | | | | | |
| | | Elastomer | Acrylic | — | — | 0.5 | 40 | 13 |
| | | | block | | | | | |
| | | | polymer | | | | | |
| | | Elastomer content | | 0 | 0.5 | 0.5 | 40 | 13 |
| Curing | Application amount (g/m²) | | | 10.4 | 10.4 | 10.4 | 10.4 | |
| agent | Composition | Curing | 1,2-DMZ | 80 | 80 | 80 | 80 | |
| liquid | (mass %) | agent | (imidazole) | | | | | |
| composition | | Solvent | EtOH | 20 | 20 | 20 | 20 | |
| Curing | Thickness (μm) | | | | | | | 25 |
| agent | Composition | Elastomer | Acrylic block | | | | | 100 |
| (sheet) | (part by | | polymer | | | | | |
| | mass) | Curing | 1,2-DMZ | | | | | 80 |
| | | agent | (imidazole) | | | | | |
| Physical | Shear | Room temperature, | | 8.9 | 9.7 | 9.5 | 9.1 | 1.3 |
| properties | adhesive | 72 h after | | | | | | |
| | force (Mpa) | | | | | | | |
| | Elastic | 24 h after | | 7.8.E+08 | 5.7.E+07 | 3.8.E+08 | 3.6.E+08 | Tacky |
| | modulus | | | | | | | |
| | (Pa) after | 72 h after | | 9.4.E+08 | 7.3.E+08 | 7.8.E+08 | 4.5.E+08 | Tacky |
| | curing | | | | | | | |

As seen from the results in Table 1, the adhesive kit according to each Example includes: an adhesive layer containing an epoxy resin and an elastomer, and a curing agent liquid composition capable of curing the adhesive layer by contact and a reaction with the adhesive layer, in which the adhesive layer contains 1 mass % to 30 mass % of the elastomer, so that complicated steps are not required, curing can be performed at room temperature in a short time, and the adhesive force after curing is excellent.

In contrast, in the adhesive kit in Comparative Example 1, an elastomer is not used in the adhesive layer, so that the shear adhesive force decreases.

In addition, in the adhesive kits in Comparative Examples 2 and 3, the content of the elastomer in the adhesive layer is less than the lower limit defined by the present invention, so that the shear adhesive force decreases.

In addition, in the adhesive kit in Comparative Example 4, the content of the elastomer in the adhesive layer is more than the upper limit defined by the present invention, so that the shear adhesive force decreases.

In addition, in the adhesive kit in Comparative Example 5, the curing agent liquid composition is not used, but a solid curing agent sheet is used, so that curing is delayed and tack is observed, making it impossible to measure the elastic modulus after curing.

Although various embodiments have been described above with reference to the drawings, the present invention is not limited to these examples. It is apparent to those skilled in the art that various alterations or modifications can be conceived within the scope described in the claims, and it is understood that the alterations or modifications naturally fall within the technical scope of the present invention. In addition, the components described in the above embodiments may be freely combined without departing from the spirit of the invention.

Note that the present application is based on a Japanese patent application (No. 2021-159642) filed on Sep. 29, 2021, the contents of which are incorporated as a reference in the present application.

### REFERENCE SIGNS LIST

1 adhesive layer
2 first adherend
3 curing agent liquid composition
4 second adherend
5 cured layer
6 adhered structure
7 adhesive kit
8 substrate layer

1. An adhesive kit comprising:
an adhesive layer containing an epoxy resin and an elastomer; and
a curing agent liquid composition capable of curing the adhesive layer by contact and a reaction with the adhesive layer, wherein
the adhesive layer contains 1 mass % to 30 mass % of the elastomer.

2. The adhesive kit according to claim 1, wherein the elastomer is dispersed in the adhesive layer.

3. The adhesive kit according to claim 1, wherein the elastomer is elastomer fine particles having an average particle diameter of 0.05 μm or more and 0.5 μm or less.

4. The adhesive kit according to claim 1, wherein the elastomer is a block polymer containing a block body compatible with the epoxy resin and a block body incompatible with the epoxy resin.

5. The adhesive kit according to claim 1, wherein the adhesive layer has a thickness of 3 μm or more and 100 μm or less.

6. The adhesive kit according to claim 1, wherein the adhesive layer has an elastic modulus of 1.0×10⁸ Pa or more at room temperature (25° C.) 24 hours after start of curing.

7. The adhesive kit according to claim 1, wherein the adhesive layer has an elastic modulus of 5.0×10⁸ Pa or more at room temperature (25° C.) 24 hours after start of curing.

8. The adhesive kit according to claim 1, wherein the adhesive layer has a shear adhesive force of 10 MPa or more after curing.

9. An adhesion method comprising:
providing an adhesive layer and a curing agent liquid composition between a first adherend and a second adherend; and
adhering the first adherend and the second adherend to each other, wherein
the adhesive layer contains an epoxy resin and an elastomer, and
the adhesive layer contains 1 mass % to 30 mass % of the elastomer.

10. The adhesion method according to claim 9, comprising:
a step (1) of disposing the adhesive layer on the first adherend;
a step (2) of providing the second adherend with the curing agent liquid composition capable of curing the adhesive layer by contact and a reaction with the adhesive layer; and
a step (3) of bringing the adhesive layer and the curing agent liquid composition into contact with each other to sandwich the adhesive layer and the curing agent liquid composition between the first adherend and the second adherend.

11. The adhesion method according to claim 9, comprising:
a step (11) of disposing the adhesive layer on the first adherend;
a step (12) of providing the adhesive layer with the curing agent liquid composition capable of curing the adhesive layer by contact and a reaction with the adhesive layer; and
a step (13) of disposing the second adherend on the adhesive layer.

12. An adhered structure comprising:
a first adherend;
a second adherend disposed to face the first adherend; and
a cured layer sandwiched between the first adherend and the second adherend, wherein
the cured layer is a cured layer obtained by a reaction between an adhesive layer and a curing agent liquid composition,
the adhesive layer contains an epoxy resin and an elastomer, and
the adhesive layer contains 1 mass % to 30 mass % of the elastomer.

13. The adhesive kit according to claim 2, wherein the elastomer is elastomer fine particles having an average particle diameter of 0.05 μm or more and 0.5 μm or less.

14. The adhesive kit according to claim 2, wherein the elastomer is a block polymer containing a block body compatible with the epoxy resin and a block body incompatible with the epoxy resin.

15. The adhesive kit according to claim 2, wherein the adhesive layer has a thickness of 3 μm or more and 100 μm or less.

16. The adhesive kit according to claim 2, wherein the adhesive layer has an elastic modulus of 1.0×10⁸ Pa or more at room temperature (25° C.) 24 hours after start of curing.

17. The adhesive kit according to claim 2, wherein the adhesive layer has an elastic modulus of 5.0×10⁸ Pa or more at room temperature (25° C.) 24 hours after start of curing.

18. The adhesive kit according to claim 2, wherein the adhesive layer has a shear adhesive force of 10 MPa or more after curing.
